(19) United States
(12) Patent Application Publication
(10) Pub. No.: US 2011/0074123 A1
(43) Pub. Date: Mar. 31, 2011

(54) Suspension Actuator for a Roll Control System

(76) Inventors: Wayne Robert Fought, Mt. Carmel, TN (US); Richard J. Barron, Ann Arbor, MI (US); Ryan Mark Belleau, Catharines (CA)

(21) Appl. No.: 12/303,328

(22) PCT Filed: Jun. 5, 2007
(86) PCT No.: PCT/US07/13192

§ 371 Date: Nov. 1, 2010

(30) Foreign Application Priority Data
Jun. 5, 2006 (US) 11/446900

(51) Int. Cl. B60G 17/00; F16L 41/00

(52) U.S. Cl. 280/5.508; 137/561 A

(57) ABSTRACT

A hydraulically operated actuator is provided for controlling a roll of a vehicle that includes an actuator connected between a first mass and a second mass of the vehicle. An upper mount assembly is coupled to the first mass and a lower mount assembly is coupled to the second mass. A high-pressure chamber is disposed between the lower mount assembly and the upper mount assembly. The high-pressure chamber has a variable volume of hydraulic fluid disposed therein for selectively restricting the movement between the upper mount assembly and the lower mount assembly. A low-pressure accumulator includes a portal for receiving hydraulic fluid from the high-pressure chamber.

### CROSS-REFERENCE TO RELATED APPLICATIONS

This application claims the benefit of U.S. patent application Ser. No. 11/446,900, filed Jun. 5, 2006, the disclosure of which is incorporated herein by reference in entirety.

### BACKGROUND OF THE INVENTION

The present invention relates in general to a suspension system, and more specifically, to a roll control actuator.

Suspension systems for a motor vehicle are known which isolate the vehicle from irregularities in the road terrain over which the vehicle travels.

Suspension systems typically include a sway bar, also known as a roll bar or a stabilizer bar, which couples the suspension on each side of a vehicle to one another. The sway bar assists in maintaining even compression on each side of the vehicle suspension. For a vehicle in a cornering maneuver having no sway bar, one side of a vehicle suspension will be under compression and the other side will have no or very little compression applied. For a vehicle having a sway bar, compression is maintained on both sides of the vehicle during a cornering maneuver. Maintaining compression on both sides of the vehicle while going about a turn minimizes the chances of the vehicle wheels lifting off the ground and reducing the stability of the vehicle.

A semi-active suspension system normally includes a spring and damper connected between the sprung portions (e.g. body) and unsprung portions (vehicle frame) of the vehicle. Semi-active suspension systems are generally self-contained, and only react to the loads applied to them. In active suspension systems, by contrast, the reactions to the applied loads are positively supplied, typically by electronically controlled hydraulic or pneumatic actuators.

An actuator for a semi-active suspension system typically utilizes a spring biased piston assembly in cooperation with the self-contained hydraulic fluid chambers (damper) for dampening sudden deflections in the suspension system caused by irregularities in the road terrain and for maintaining a rigid suspension system when cornering. The actuator typically utilizes a high-pressure chamber and a storage chamber for transferring hydraulic fluid within the actuator for allowing the compression of the actuator. Typically, the high-pressure chamber is formed about the piston assembly and maintains a resistive force on the spring-biased piston for gradually controlling the axial movement of the actuator. In such an arrangement, when in a dampening mode, hydraulic fluid is allowed to flow from the high-pressure chamber to the storage chamber via the compression force exerted on the actuator. The resistive force of the spring biased piston and the withdrawal of hydraulic fluid from the high-pressure chamber provides for a gradual smooth movement of the actuator. When the force is no longer applied to the actuator, the spring-biased piston uncompresses and moves back to its extended position. As the piston moves back to the extended position, hydraulic fluid flows from the storage chamber to the high-pressure chamber via a vacuum or low pressure created by the piston assembly, which provides a gradual return to its extended position.

Typically, for straight road driving, a solenoid valve is in an open position for allowing hydraulic fluid to exit the high-pressure chamber of the actuator, which allows the actuator to compress and dampen deflections in the suspension system. When a vehicle is cornering, the solenoid valve is in a closed position for preventing hydraulic fluid from leaving the high-pressure chamber. This prevents the actuator from compressing so that a rigid suspension system is maintained.

As the vehicle travels over uneven terrain (with the solenoid valve in the open position), the actuator constantly compresses and uncompresses, thereby forcing hydraulic fluid in and out of both the high-pressure chamber and the storage chamber. The storage chamber is typically filled with a gas, such as nitrogen. Gas is produced within the hydraulic fluid in the storage chamber when the hydraulic fluid jets into the storage chamber and breaks the surface interface of the hydraulic fluid and air therein. If hydraulic fluid is allowed to jet into the storage chamber and break the surface of the hydraulic fluid in the storage chamber, gas bubbles will be produced within the hydraulic fluid. Hydraulic fluid is noncompressible; however, as gas bubbles are mixed into the hydraulic fluid, the hydraulic fluid within the high-pressure chamber becomes compressible due to the gas bubbles being compressible. The gas bubbles allow for compression in the high-pressure chamber even when the solenoid valve is in a closed position. This reduces the rigidity of the suspension system when a rigid suspension system is desired.

### BRIEF SUMMARY OF THE INVENTION

In one aspect, the present invention has the advantage of utilizing a flow diverter in a roll control actuator for preventing gas bubbles from forming in a low-pressure accumulator as pressurized hydraulic fluid is transferred from a high-pressure chamber to the low-pressure accumulator.

In one embodiment of the invention, a hydraulically operated actuator is provided for controlling a roll of a vehicle. The actuator is connected between a first mass of the vehicle and a second mass of the vehicle. An upper mount assembly is coupled to the first mass of the vehicle. A lower mount assembly is coupled to the second mass of the vehicle. A variable high-pressure chamber is disposed between the lower mount assembly and the upper mount assembly, the variable high-pressure chamber having a variable volume of hydraulic fluid disposed therein for selectively dampening the movement between the upper mount assembly and the lower mount assembly. A low-pressure accumulator includes a portal for receiving hydraulic fluid from the high-pressure chamber. The hydraulic fluid is in fluid communication between the high-pressure chamber and the accumulator. An anti-aeration assembly for minimizing gas bubbles from transitioning between the high-pressure chamber and the accumulator, the antiaeration assembly being disposed within the accumulator.

In yet another embodiment of the invention, an actuator assembly is provided for controlling vehicle suspension rigidity. The actuator includes an upper mount assembly coupled to a suspension member. A lower mount assembly is coupled to a vehicle frame. A piston assembly includes a piston rod and a piston. The piston rod is coupled to the upper mount assembly for maintaining a variably spaced relationship between the upper mount assembly and the lower mount assembly. An accumulator is disposed between the upper mount assembly and the lower mount assembly for storing a variable amount of hydraulic fluid. The accumulator includes a first portal for receiving hydraulic fluid flow into the accumulator. A high-pressure chamber contains hydraulic fluid, the high-pressure chamber being selectively compressible. A solenoid valve is interposed between the high-pressure chamber and the accumulator for selectively controlling pressure within the high-pressure chamber by controlling the fluid flow from the high-pressure chamber to the accumulator. The solenoid valve when in an open position allows fluid flow from the high-pressure chamber to the accumulator as the high-pressure chamber is compressed. A flow diverter within the accumulator directs a flow of hydraulic fluid flow from the high-pressure chamber to the accumulator. The flow diverter minimizes the hydraulic fluid flow into the accumulator from forming gas bubbles in the hydraulic fluid.

In yet another embodiment of the invention, an anti-aeration system is provided for a gas and fluid filled reservoir in a hydraulic suspension actuator. The actuator is hydraulically operated for controlling a roll of a vehicle. The actuator is connected between a first mass of the vehicle and a second mass of the vehicle. The actuator includes an upper mount assembly coupled to the first mass of the vehicle and a lower mount assembly coupled to the second mass of the vehicle. A high-pressure chamber is disposed between the lower mount assembly and the upper mount assembly. The high-pressure chamber has a variable volume of hydraulic fluid disposed therein for selectively dampening the movement between the upper mount assembly and the lower mount assembly. A low-pressure accumulator includes a first portal for selectively receiving hydraulic fluid from the high-pressure chamber and a second portal disposed on a bottom surface of the accumulator for allowing hydraulic fluid to exit from the accumulator to the high-pressure chamber. A flow diverter for redirecting a flow of hydraulic fluid within the accumulator minimizes the formation gas bubbles in the hydraulic fluid within the accumulator. A fence portion is disposed around the second portal for minimizing gas bubbles suspended in the hydraulic fluid of the accumulator from entering the second portal.

In yet another embodiment of the invention, a hydraulic actuator for controlling the roll of a vehicle includes an anti-aeration assembly disposed within an accumulator for minimizing aeration of hydraulic fluid transitioning between the chamber and the accumulator.

In yet another embodiment of the invention, an actuator for controlling the roll of a vehicle has an anti-aeration assembly including an investment casting with an integral flow deflector.

In yet another embodiment, an actuator for controlling the roll of a vehicle includes a component affixed to upper and lower housing portions by metal fusing.

In yet another embodiment, a piston assembly for an actuator for controlling the roll of a vehicle includes a rod and a piston wherein an end of travel of the rod is dampened by a volume of fluid between a head of the rod and a respective end of a chamber of the piston.

In yet another embodiment, a piston assembly for an actuator for controlling the roll of a vehicle includes a rod and a piston. The piston assembly includes a cushion mounted on one end of the piston. The cushion dampens the travel of the piston as approaching the end of a piston housing

In yet another embodiment, an actuator for controlling the roll of a vehicle includes a piston housing and a piston assembly. The housing includes a collar that cooperates with an end of the piston to form a pocket of dampening hydraulic fluid.

In yet another embodiment, a piston assembly for an actuator for controlling the roll of a vehicle includes a piston having a snap fit check valve assembly in an end of the piston.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is an exploded perspective view of an actuator for controlling the roll of a vehicle according to a first preferred embodiment of the invention.

FIG. 2 is partial cross section view of the actuator according to the first preferred embodiment of the present invention.

FIG. 3 is an enlarged view of the encircled portion of FIG. 1 according to the first preferred embodiment of the present invention.

FIG. 4 is a perspective view of a flow diverter according to a second preferred embodiment of the present invention.

FIG. 5 is a perspective view of a flow diverter according to a third preferred embodiment of the present invention.

FIG. 6 is a perspective view of a flow diverter according to a fourth preferred embodiment of the present invention.

FIG. 7 is a perspective view of a flow diverter according to a fifth preferred embodiment of the present invention.

FIG. 8 is a perspective view of a flow diverter according to a sixth preferred embodiment of the present invention.

FIG. 9 is a perspective view of a portion of an accumulator according to a seventh preferred embodiment of the present invention.

FIG. 10 is a perspective view of a portion of an accumulator according to an eighth preferred embodiment of the present invention.

FIG. 11 is a perspective view of a portion of an accumulator according to a ninth preferred embodiment of the present invention.

FIG. 12 is a perspective view of a portion of an accumulator according to a tenth preferred embodiment of the present invention.

FIG. 12a is a cross-sectional view of the flow deflector of FIG. 12.

FIG. 13 is a partial cross-sectional perspective view of an actuator according to an eleventh preferred embodiment of the present invention.

FIG. 14 is a perspective view of a portion of an actuator according to a twelfth preferred embodiment of the present invention.

FIG. 15 is a perspective view of a portion of an actuator according to a thirteenth preferred embodiment of the present invention.

FIG. 16 is a partial cross-sectional perspective view of the actuator of FIG. 15.

FIG. 17 is a partially exposed view of an actuator according to a fourteenth preferred embodiment of the present invention.

FIG. 18 is a partially exposed view of the actuator of FIG. 17 with the piston at the end of travel.

FIG. 19 is a cross-sectional perspective view of the actuator of FIG. 17 nearing the end of travel.

FIG. 20 is a partial cross-sectional view of a portion of an actuator according to a fifteenth preferred embodiment of the present invention.

FIG. 21 is an exploded view of the check valve of FIG. 20.

FIG. 22 is a partial cross-sectional view of a portion of the check valve of FIG. 20.

FIG. 23 is a schematic view of a vehicle system utilizing an actuator for a roll control system according to a sixteenth preferred embodiment of the present invention.

### DETAILED DESCRIPTION OF THE PREFERRED EMBODIMENTS

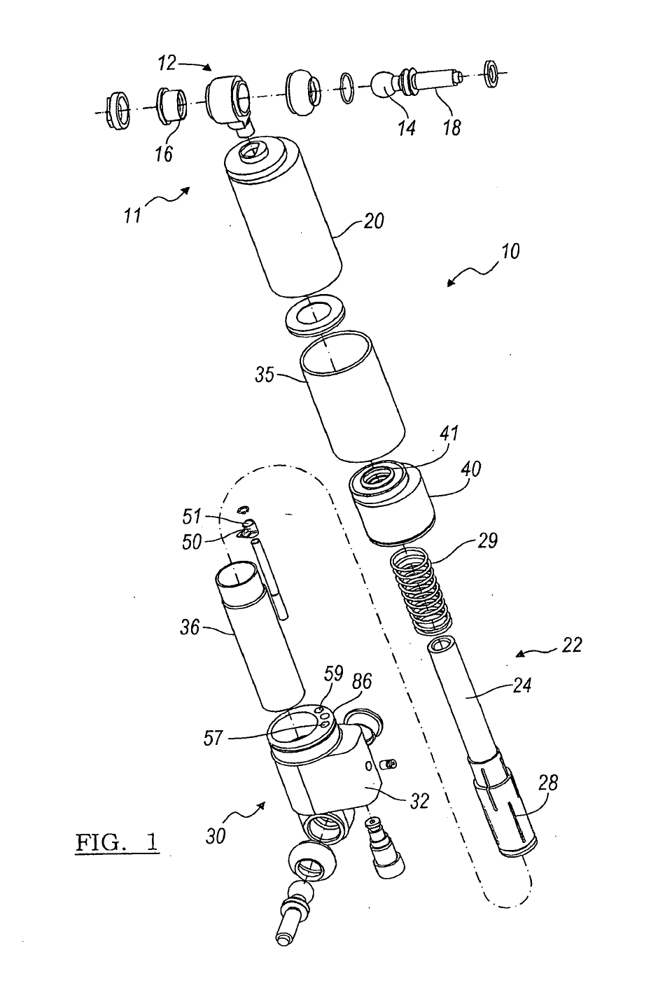

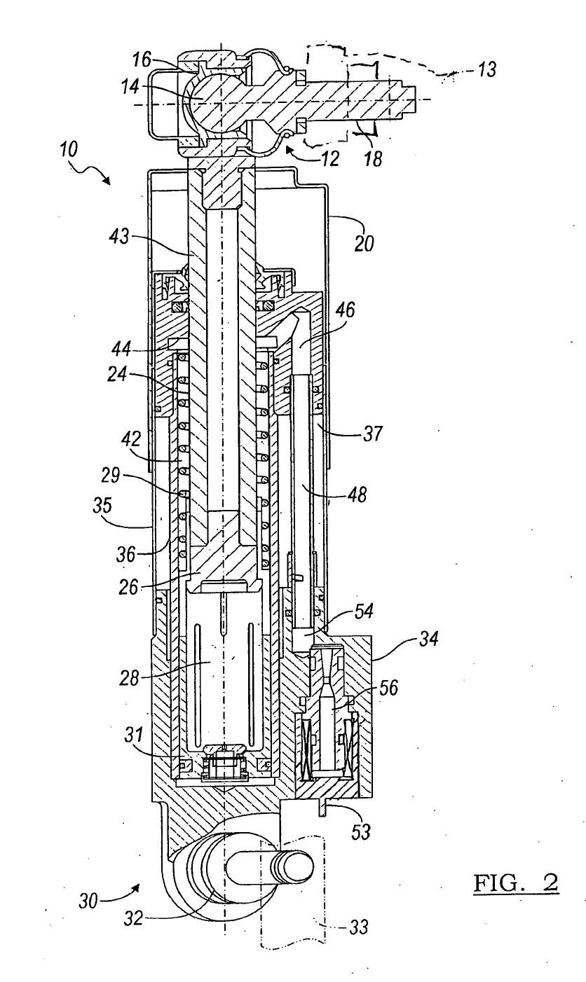

Referring now to the drawings, there is illustrated in FIGS. 1 and 2 a self-contained hydraulic fluid actuator 10 for a semi-active roll control system. The actuator 10 includes an upper mount assembly 11 for attachment to a first mass 13 of a vehicle such as a vehicle frame member. The upper mount assembly 11 includes an upper ball joint assembly 12 having a pivot ball 14 interconnected to a socket 16 which allows for circumferential movement of the actuator 10 in relation to the attaching vehicle frame member. The pivot ball 16 is also coupled to a pivot shaft 18 for attachment to the vehicle frame member.

The upper mount assembly 11 also includes a dust cover 20. The dust cover 20 functions as a protective guard against debris (e.g., stones) from the road that may cause damage to any underlying components of the actuator 10. A piston assembly 22 is also coupled to the upper mount assembly 11. The piston assembly 22 includes a piston rod 24, a piston rod head 26, a piston 28, and a piston spring 29. The piston rod 24 is coupled to the piston rod head 26 (e.g., threaded) or may be formed integral as one component. The piston 28 includes a check valve assembly 31 coupled to a bottom surface of the piston 28. Preferably, the piston 28 is a free-floating piston that is slideable over the piston rod head 26 as described in co-pending application U.S. Ser. No. 10/892,484 filed Jul. 16, 2004, which is incorporated herein by reference.

The actuator 10 further includes a lower mount assembly 30. The lower mount assembly 30 includes a fastening member 32 coupled to a second mass 33 of the vehicle such as a sway bar (sprung member). The lower mount assembly 30 further includes a lower housing portion 34. An inner tubular member 36 spaced radially outward from the piston assembly 22 extends into the lower housing portion 34 and is coupled to the lower housing portion 34 therein. An outer tubular member 35 spaced radially outward from the inner tubular member 36 is sealing engaged to the lower housing portion 34. A low-pressure accumulator 37 is formed between the outer tubular member 35 and the inner tubular member 36. The accumulator 37 is partially filled with hydraulic fluid and partially filled with a gas, such as nitrogen. A high-pressure chamber 42 is formed between the inner tubular member 36 and the piston assembly 22.

A cap assembly 40 is seated on top of the outer tubular member 35 and the inner tubular member 36. The cap assembly 40 includes a centered aperture 43 for receiving the piston rod 24 axially therethrough for attachment to the upper mount assembly 11. The piston spring 29 extends axially around the piston rod 24. The ends of the piston spring 29 are bound by an abutment portion 44 of the upper cap assembly 40 and an abutment portion 46 of the piston 28.

The cap assembly 40 is disposed above the high-pressure chamber 42 and is in fluid communication with the high-pressure chamber 42. The cap assembly 40 includes a fluid conduit 46 that coupled to a transfer tube 48 disposed within the accumulator 37. Pressurized hydraulic fluid exits from the top of the high-pressure chamber 42 via the first conduit 46 and is provided to the transfer tube 48. The transfer tube 48 extends between the upper cap assembly 40 and the lower housing assembly 34 within the accumulator 37 for allowing fluid flow between the upper cap assembly 40 and a solenoid valve 56 disposed in the lower housing assembly 34. The valve 56 is only schematically illustrated in FIG. 2. The valve 56 controls fluid flow between the interior of the lower housing assembly 34 and a first passageway 54 and the accumulator 37. For example, the valve 56 maybe the valve shown in FIG. 6 of PCT Patent Application Publication WO 2006/118576 A2.

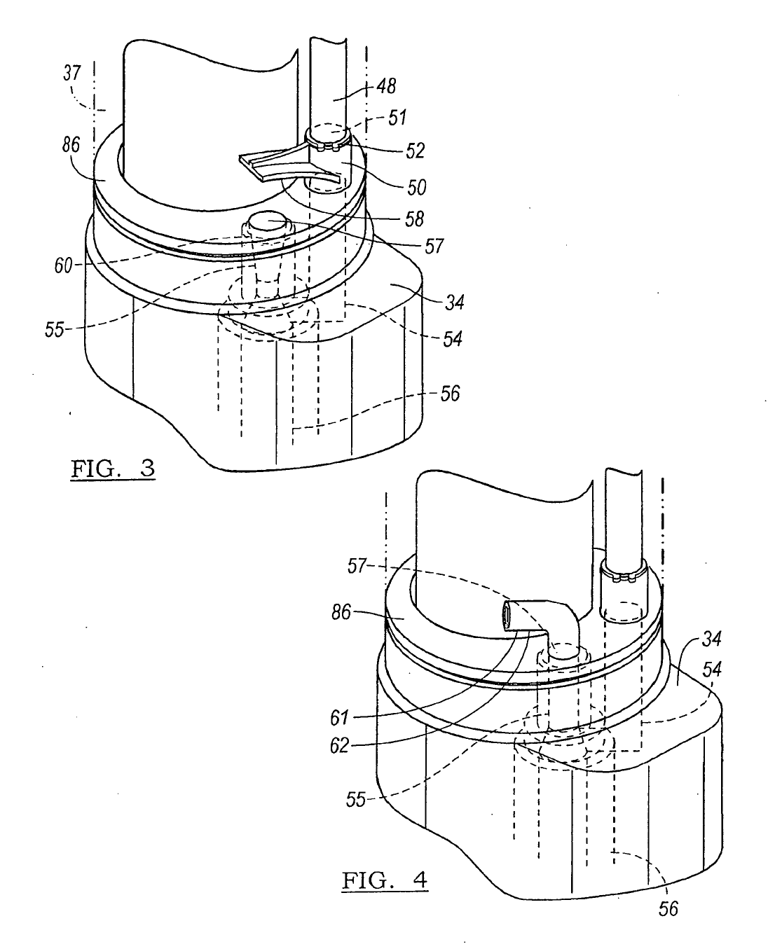

Referring to FIG. 3, a flow deflector 50 is disposed within the accumulator 37 above a portal 57. The flow deflector 50 includes a bore 51 for receiving the transfer tube 48 therethrough. The bore 51 of the flow deflector 50 is slideable over the exterior surface of the transfer tube 48. The flow deflector 50 is secured to the transfer tube 48 by attaching a retaining ring 52 in a grooved section of the transfer tube 48 for locating the flow deflector 50 on the transfer tube 48 at a desired location within the accumulator 37. The flow deflector 50 functions as a bushing for locating the transfer tube 48 when the transfer tube 48 is aligned and inserted into the lower housing assembly 34.

The lower housing assembly 34 further includes the first passageway 54 that fluidically connects the transfer tube 48 to the solenoid valve 56 disposed within the lower housing assembly 34. A second passageway 55 fluidically connects the accumulator 37 to the solenoid valve 56. The solenoid valve 56 includes electrical leads 53 (shown in FIG. 2) that receive power to energize the solenoid valve 56 to an open or closed position for allowing hydraulic fluid flow between the first passageway 54 and the second passageway 55. When the solenoid valve 56 is actuated to allow hydraulic fluid flow from the high-pressure chamber 42 to the accumulator 37, pressurized hydraulic fluid jets through the portal 57 leading into the accumulator 37. Preferably, the flow passages from passageway 54 to passageway 55 includes a convergence/divergence section for increasing pressure and decreasing fluid flow rate to produce a venturi action for reducing the jet stream and turbulence and placing a backpressure on the solenoid valve 56. A diverging portion 60 includes a gradual widened opening for decreasing fluid flow rate into the accumulator 37. The gradual widened opening extending to the first portal 59 functions to decelerate the fluid flow rate and gradually allow the fluid flow to reach a substantially same pressure as that in the accumulator 37.

A portion of the flow deflector 50 is positioned directly above the portal 57 for preventing hydraulic fluid from jetting above the surface of the hydraulic fluid stored in the accumulator 37. Preventing the jetted hydraulic fluid from breaching the surface of the hydraulic fluid within the accumulator 37 substantially reduces the formation of gas bubbles within the hydraulic fluid.

A controller (not shown) provides control signals to energize the solenoid valve 56 between the open or closed position depending on the vehicle operating conditions. The controller senses a plurality of operating conditions, including but not limited to speed, lateral acceleration, and steering wheel angle. A semi-active roll control algorithm will process the information and, based on the sensed inputs, will produce a control command indicating whether to close or open the solenoid valve 56 for maintaining a rigid or non-rigid suspension system.

As the force exerted on the lower mount assembly 30 is removed, the piston spring 29 uncompresses and forces the piston 28 back to an extended position (or centered position). As the piston transitions from a compressed position to the extended position, the positioning of the piston in cooperation with a pressure differential causes hydraulic fluid to be drawn from the accumulator 37 back into the high-pressure chamber 42. Hydraulic fluid is drawn from the accumulator 37 to the high-pressure high-pressure chamber 42 by a second portal 59 (shown in FIG. 1). The second portal 59 is disposed on a bottom surface 86 of the accumulator 37. The second portal 59 allows fluid to flow from the accumulator 37 to the high-pressure chamber 42 depending on the pressure differential and the placement of the piston.

The flow deflector 50 includes a substantially arc-shaped underbody surface 58. The flow deflector 50 is positioned over the portal 57 of the second passageway 55. Hydraulic fluid forced into the accumulator 37 under high pressure from the portal 57 jets into the accumulator 37 in a vertical upward direction. The jetted hydraulic fluid is gradually deflected in a substantially horizontal direction by the arc-shaped underbody surface 58 of the flow deflector 50. Thus, the deflected hydraulic fluid flows in a horizontal circular direction and is prevented from flowing upward and breaching the surface of the existing hydraulic fluid within the accumulator 37. Preventing the jetted hydraulic fluid from breaking the surface of the hydraulic fluid minimizes the gas bubbles within the hydraulic fluid in the accumulator 37.

FIG. 4 illustrates an enlarged view of a flow diverter 61 attached to the lower housing portion 34 according to a second preferred embodiment. The flow diverter 61 includes an arc-shaped fluid conduit 62 extending from the portal 57 of the second passageway 55. The fluid conduit 62 curves from a vertical direction to a substantially horizontal direction. Fluid jetting from the portal 57 of the second passageway 55 enters the flow diverter 61 and is redirected in a substantially horizontal direction. This prevents the hydraulic fluid exiting the flow diverter 61 from flowing in a direction that could break the surface of the hydraulic fluid stored within the accumulator 37, thus minimizing the gas bubbles therein.

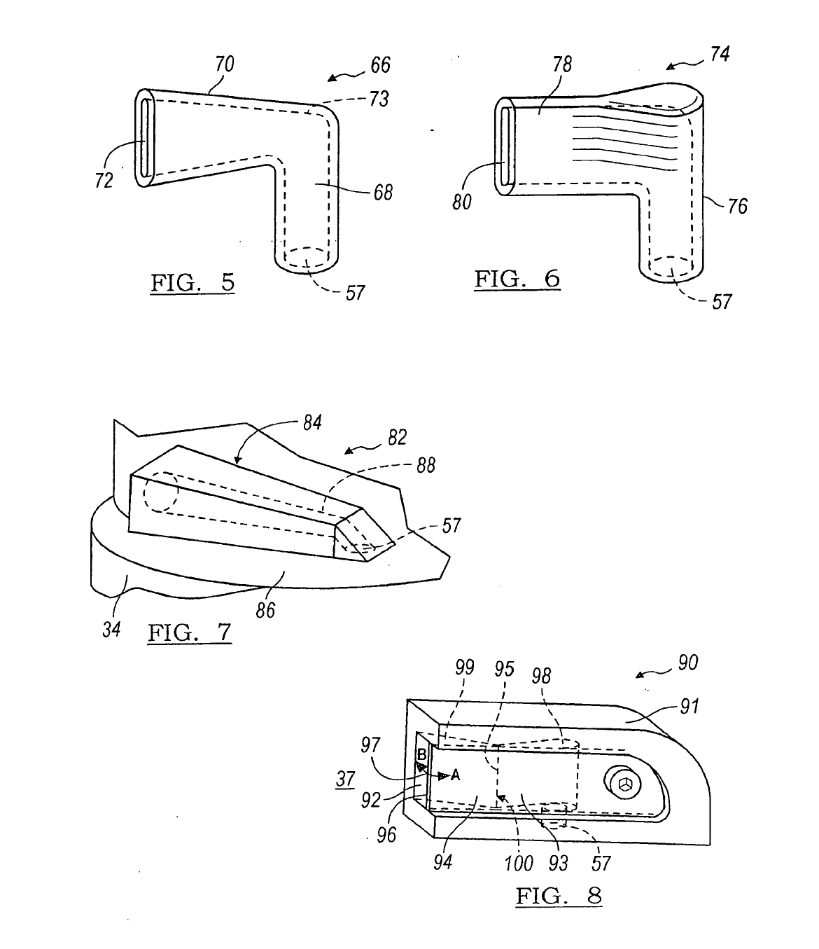

FIG. 5 is a third embodiment illustrating a flow diverter 66 for diverting the hydraulic fluid flow entering the accumulator 37 (such as one shown in FIGS. 2 and 3). The flow diverter 66 includes a vertical tubular section 68 that is coupled to the portal 57 of the second passageway 55 (not shown in this figure). A flattened tubular section 70 extends substantially 90 degrees from the vertical tubular section 68. An opening 72 of the flattened tubular section 70 includes a flattened widened mouth. The flow diverter 66 is preferably made of an elastomeric material such as rubber, but may be made of other types of materials if so desired. Fluid entering the accumulator 37 is directed in a substantially horizontal direction for preventing it from breaking the surface of the hydraulic fluid, thus minimizing gas bubbles in the hydraulic fluid. The flow diverter 66 functions as a venturi for hydraulic fluid flowing between the accumulator 37 and the high pressure chamber 42 (not shown in this figure). A narrowed neck section 73 between the vertical tubular section 68 and the widened mouth opening 72 functions as a convergent/divergent section for creating a venturi effect.

The flow diverter 66, if made of an elastomeric material, also has the advantage of functioning like a check valve for preventing the return of hydraulic fluid from the accumulator 37 to the high-pressure chamber 42 via the flow diverter 66. In the unlikelihood of a small amount of gas bubbles formed in the hydraulic fluid of the accumulator 37, gas bubbles could return to the high-pressure chamber 42 via the perspective flow diverter. That is, gas bubbles formed in the liquid float upward; however, because of the viscosity of the hydraulic fluid (e.g., oil), the gas bubbles may not disperse above the surface of the hydraulic fluid in a timely manner that would be warranted. Rather, the gas bubbles may be slow to float to the surface and may remain suspended in the hydraulic fluid. Under such conditions, a respective flow diverter having an opening at a respective height above the bottom surface of the accumulator 37 may be susceptible to allowing gas bubbles suspended within the hydraulic fluid to flow therein to the high-pressure chamber 42. Unlike portal 57 disposed on the bottom surface 86 of the accumulator 37, as shown in FIG. 3, respective flow diverters extending into the accumulator 37 and having their respective portal openings at an elevated distance above the bottom surface 86 of the accumulator 37 are susceptible to allowing gas bubbles suspended in the accumulator 37 to flow to the high pressure chamber 42 back through the respective flow diverter. This is primarily due to a respective flow diverter having an elevated opening in a region of the accumulator 37 where gas bubbles may be suspended. The flow diverter 66, as shown in FIG. 5, prevents hydraulic fluid flow from re-entering the opening 72 of the flow-diverter 66 as a result of the geometric shape of the tubular section 70 and its elastomeric properties. A vacuum flow created from the accumulator 37 to the high-pressure chamber 42 would cause the opening 72 to close and seal itself thereby restricting reverse flow through the flow diverter 66. Fluid returning to high-pressure chamber 42 would exit the accumulator 37 via the second portal 59 (shown in FIG. 1) disposed on the bottom surface of the accumulator 37.

FIG. 6 is a flow diverter 74 according to a fourth preferred embodiment of the present invention. The flow diverter 74 is similar to the flow diverter 66 of FIG. 4. The flow diverter 74 includes a vertical tubular section 76, which extends into the opening 57 of the second passageway 55 (not shown in this figure). A flattened tubular section 78 extends substantially 90 degrees from the vertical tubular section 76. Fluid entering the accumulator 37 (now shown in this figure) is directed in a substantially horizontal direction, preventing the in-flowing hydraulic fluid from breaking the surface, thus minimizing gas bubbles in the hydraulic fluid. The flattened tubular section 78 includes a flattened uniform section that extends laterally to an opening 80. The flow diverter 74 resembles that of Bunsen valve. A vacuum flow created from the accumulator 37 to the high-pressure chamber 42 (not shown in this figure) causes the opening 80 to close and seal itself thereby restricting reverse flow through the flow diverter 74.

FIG. 7 shows a flow diverter 82 according to a fifth preferred embodiment of the present invention. The flow diverter 82 may be integral to the lower housing portion 34. The flow diverter 82 includes a tubular segment 84 that extends laterally along the bottom surface 86 of the accumulator 37 (not shown in this figure). The flow diverter 82 includes a substantially horizontal passageway 88, which extends from the opening 57 of the second passageway 55 (not shown in this figure) to the accumulator 37. Hydraulic fluid exiting the flow diverter 82 is directed in a substantially horizontal direction into the accumulator 37, thereby minimizing gas bubbles in the hydraulic fluid in the accumulator 37 that would otherwise be formed if the incoming hydraulic fluid broke the surface of the hydraulic fluid within the accumulator 37. The flow diverter 82 can be seated low with respect to the bottom surface 86 when formed integral with the lower housing portion 34. This minimizes the return of entrapped gas bubbles suspended in the hydraulic fluid from flowing through the flow diverter 82 since entrapped gas is typically not suspended close to the bottom surface 86.

FIG. 8 shows a flow diverter 90 according to a sixth preferred embodiment of the present invention. The flow diverter 90 may be integral to the lower housing portion 34 or may be separately formed and coupled thereafter to the lower housing portion 34. The flow diverter 90 includes a main body portion 91. The main body portion 91 includes a wall section 92 that that has a first sloping surface 93 and a second sloping surface 94. The first sloping surface 93 and the second sloping surface 94 intersect at an apex 95.

A reed valve 96 is coupled to the main body 91 and extends laterally along the wall section 92. The reed valve 96 is made of an elastomeric material, such as rubber, which allows the reed valve 96 to move the directions as shown by the direction indicator 97 when respective forces are exerted on the reed valve 96. When no forces are acting on the reed valve 96, a portion of the reed valve 96 abuts the apex 95. Alternatively, the reed valve 96 may be positioned so that the reed valve 96 is in close proximity to the apex 95.

A first chamber portion 98 is cooperatively formed by the first sloping surface 93 and reed valve 96. The first chamber portion 98 is disposed above the portal 57 and is in fluid communication with the portal 57. The first chamber 92 widens as it extends along the first sloped surface 93 from the apex 95 to an opposing end portion of the first chamber portion 98 that is in fluid communication with the portal 57.

A second chamber portion 99 is cooperatively formed by the second sloping surface 94 and reed valve 96. The second chamber portion 99 widens as it extends from its apex 95 to an opposing end of the second chamber portion 99 that is in fluid communication with the accumulator 37.

A narrowed passageway 100 is formed between the apex 95 and the opposing section of the reed valve 96, which allows fluid flow from the first chamber portion 98 to the second chamber portion 99. When hydraulic fluid is forced from high-pressure chamber 42 (not shown) to the accumulator 37, pressurized hydraulic fluid is forced into the first chamber portion 98 via portal 57. As fluid flow increases into the first chamber portion 98, pressure builds into the tapered portion of the first chamber portion 98 to force the reed valve 96 in the direction A as indicated by the direction indicator 97. As fluid flows through the narrowed passageway 100, fluid flow increases as pressure decreases. Hydraulic fluid flows into the second chamber portion 99. The second chamber portion 99 widens as fluid flows from the apex 95, and thereafter, into the accumulator 37. As fluid flows into the widening second chamber portion 99, fluid flow decreases and pressure increases thereby reducing abrupt pressure changes and minimizing the jetting fluid and turbulence.

The hydraulic fluid entering the accumulator 37 from the second chamber portion 99 is forced in a substantially horizontal direction that prevents hydraulic fluid from jetting above the surface of the hydraulic fluid thereby minimizing the formation of gas bubbles within the hydraulic fluid of the accumulator 37.

When hydraulic fluid returns to the high-pressure chamber 42 from the accumulator 37, fluid flow is prevented from re-entering the flow diverter 90. As fluid attempts to re-enter the flow diverter 90 from the accumulator 37, a vacuum is created from the high-pressure chamber 42. The vacuum attempts to draw fluid from the accumulator 37 into the second chamber portion 99. In response to the vacuum created by the reverse fluid flow, the reed valve 96 is forced in the direction B as indicated by the direction indicator 97. The portion of the reed valve 96 collapses against the second sloped surface 93 and the apex 95 thereby stopping any additional hydraulic fluid from passing through flow diverter 90 and to the high-pressure chamber 42. Any gas bubbles suspended within the hydraulic fluid, which may have formed, are prevented from flowing to the high-pressure chamber 42 through the flow diverter 90.

It should be noted gas bubbles suspended in the high-pressure chamber 42 exit the high-pressure chamber 42 via first conduit 46 coupled to the top of the high-pressure chamber 42. The gas bubbles travel through the transfer tube 48 and into the accumulator via the first portal 57 where the hydraulic fluid and gas bubbles disposed therein are redirected in the substantially horizontal direction by a respective flow diverter. These gas bubbles circulate within the accumulator 37 and gradually rise to the top surface as the hydraulic fluid flow rate decreases within the accumulator 37 thereby purging the gas bubbles within the high-pressure chamber 42.

FIG. 9 shows a perspective view of a portion of the accumulator 37 according to a seventh preferred embodiment of the present invention. The accumulator 37 includes a portal 57 for allowing pressurized hydraulic fluid to enter the accumulator 37 from the high-pressure chamber 42 (shown in FIG. 2). A portion of the flow deflector 50 is positioned directly above the portal 57 for preventing hydraulic fluid from jetting above the surface of the hydraulic fluid stored in the accumulator 37. Preventing the jetted hydraulic fluid from breaching the surface of the hydraulic fluid within the accumulator 37 substantially reduces the formation of gas bubbles within the hydraulic fluid.

A fence portion 108 is disposed around the second portal 59 and extends vertically upward into the accumulator 37. The fence portion 108 includes a mesh-type material having mesh-like openings 109 that allows for fluid flow therethrough. As fluid exits from the accumulator 37 through the second portal 59, hydraulic fluid is drawn through fence portion 108. The fence portion 108 screens gas bubbles suspended within the hydraulic fluid of the accumulator 37 as the hydraulic fluid passes through the fence portion 108 thereby minimizing gas bubbles from flowing through the second portal 59 and to the high-pressure chamber 42.

The fence portion 108 may be extended to only a predetermined height for allowing flow over in the event the hydraulic fluid becomes highly viscous. Under certain conditions (e.g., cold weather), the hydraulic fluid within the accumulator 37 may have high viscosity. Depending upon the size of the mesh openings of the fence portion 108, hydraulic fluid may be restricted from flowing through the mesh openings of the fence portion 108 or may flow at a very slow rate. By limiting the height of the fence portion 108, the fence portion 108 may function as a weir for allowing hydraulic fluid to flow over a top unrestricted opening 110 of the fence portion 108 should the hydraulic fluid be too viscous to flow through the mesh-type openings 109 of the fence portion 108.

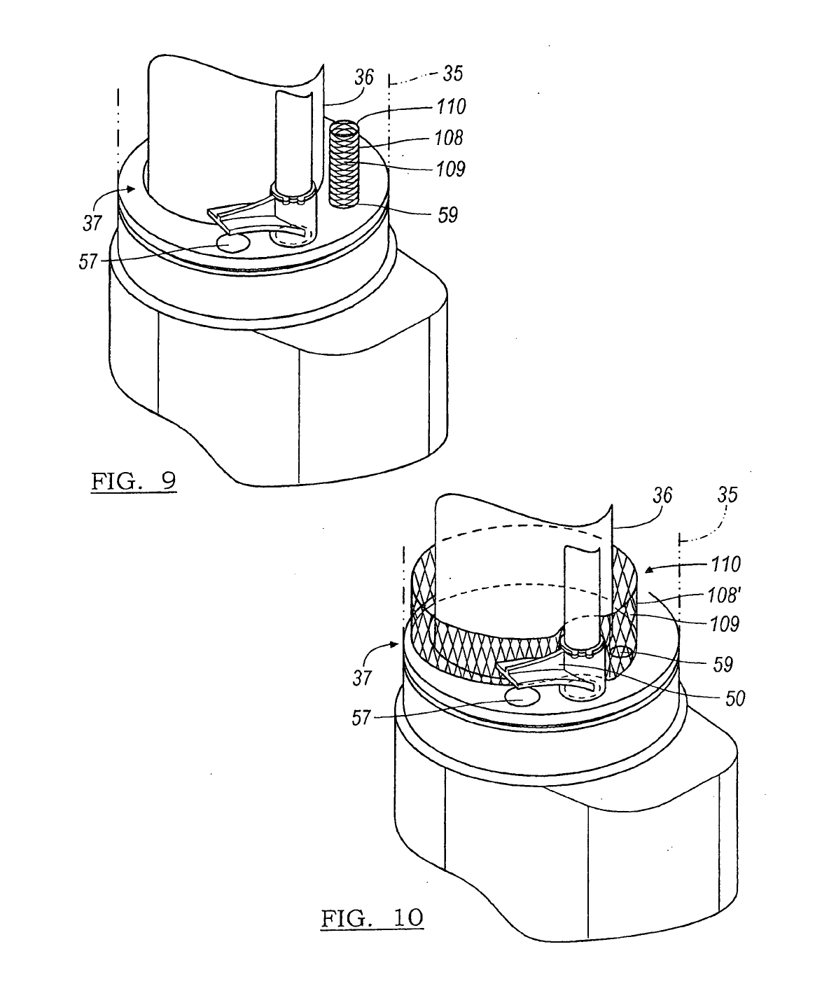

FIG. 10 shows a perspective view of an anti-aeration assembly according to an eighth preferred embodiment of the present invention. The accumulator 37 includes the second portal 59 for allowing pressurized hydraulic fluid to enter the accumulator 37 from the high pressure chamber 42

Referring to FIG. 9, during cold temperatures, the viscosity of the hydraulic fluid within the accumulator rises. The thickness of the hydraulic fluid during the cold temperatures may not allow the hydraulic fluid to flow through the mesh-like openings 109. In addition, having to too little of an existing volume of fluid within the fence portion 108 may deplete the hydraulic fluid from this region within the fence portion 108, and as a result, gas may be drawn into the second portal 57 and to the high pressure accumulator 42.

Referring again to FIG. 10, an anti-aeration system is shown for maintaining a sufficient volume of hydraulic fluid with the fence portion 108′. The fence portion 108′ is disposed radially outward and around the inner tubular member 36. The second portal 59 is disposed on the bottom surface of the accumulator between the fence portion 108′ and the inner tubular member 36. The fence portion 108′ extends to only a predetermined height above the second portal 59. As stated earlier, under cold weather conditions, the hydraulic fluid within the accumulator 37 may be too thick to flow through the mesh-like opening 109 of the fence portion 108′. When hydraulic fluid enters the accumulator 37 from the first portal 57, hydraulic fluid fills the region between the outer tubular member 35 and the fence portion 108′. As the hydraulic fluid reaches the top of the fence portion 108′, the fence portion 108′ functions as a weir by allowing hydraulic fluid to flow over a top unrestricted opening 110 of the fence portion 108′ and into the region between inner tubular member 36 and the fence portion 108′. The region between the fence portion 108′ and the inner tubular member 36 is sufficient so that when fluid is drawn out via the second portal 59, the hydraulic fluid with this region is not depleted when exiting the second portal 59.

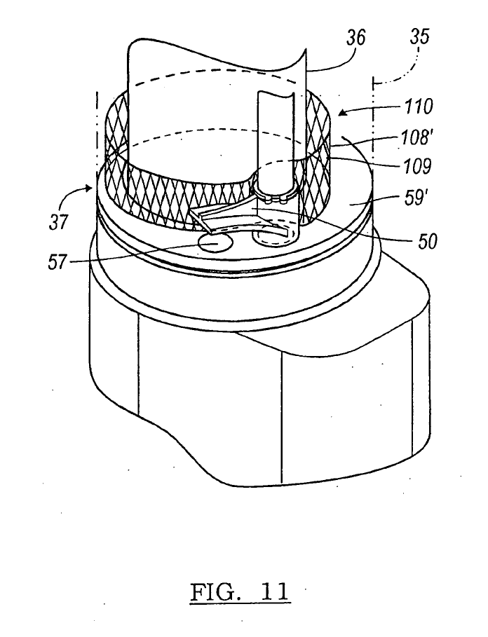

FIG. 11 shows a perspective view of an anti-aeration assembly according to a ninth preferred embodiment of the present invention. In this embodiment, a second portal 59′ is disposed centrally about the inner tubular member 36 along the bottom surface of the accumulator 37 juxtaposed to the high-pressure accumulator 42. As hydraulic fluid enters the accumulator 37 when the hydraulic fluid is cold and viscous, hydraulic fluid is allowed to flow over the top of the fence portion 108′ for maintaining a sufficient volume of fluid within this region so that gas is unable to exit through the second portal 59.

In alternative embodiments, a respective fence portion may be designed utilizing difference diameters, heights, and geometrical configurations based on the size, location, and shape of a respective second portal. In addition, the fence portion can be utilized with the various embodiments of flow diverters as discussed above. Moreover, the centrally disposed second portal 59′ may be utilized without a respective fence since gas bubbles have a tendency to float upward and away from the lower central portion of the accumulator.

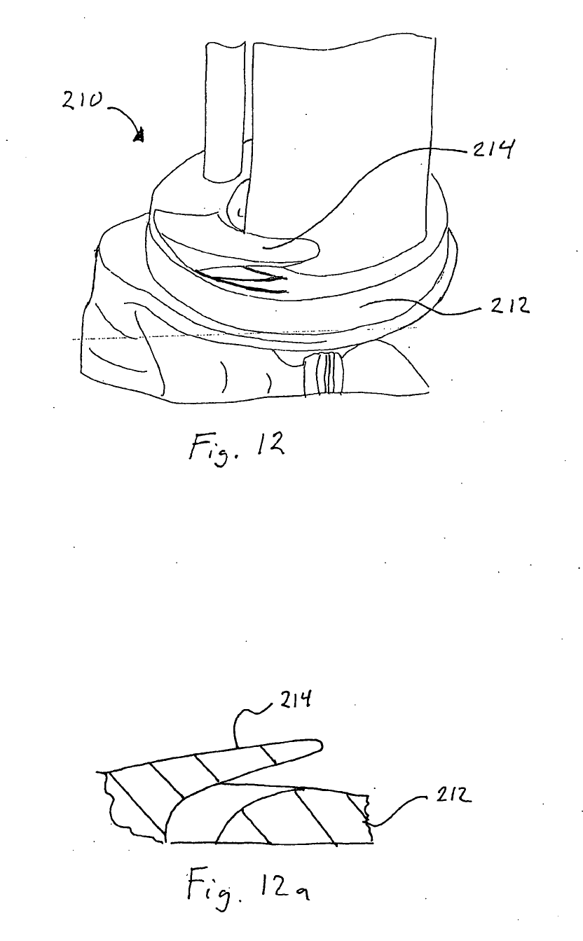

There is shown in FIGS. 12 and 12a a portion of an accumulator 210 according to a tenth preferred embodiment of the present invention. The accumulator 210 includes an investment cast portion 212 with an integral flow deflector 214. It must be understood, however, that the flow deflector 214 need not be integrally formed and that the portion 212 may be formed in any suitable manner such as other casting, stamping or forming. Preferably, the casting 212 and the deflector 214 are formed form plastic. Although it must be understood that the investment casting 212 and the deflector 214 may be made from any suitable material, such as metal, formed in any suitable manner, such as stamping molding, or pressing.

There is shown in FIG. 13 a portion of an actuator 310 according to a eleventh embodiment. In this embodiment, the actuator 310 includes a high-pressure return tube 312. The high-pressure return tube 312 is affixed to respective upper and lower housing portions 314 and 316 by metal fusing, such as brazing, soldering or welding, as indicated at 318 and 320, respectively. Preferably, although not necessarily, the brazing is oven brazing performed in a neutral atmosphere furnace. In an alternative embodiment (not shown), the upper and lower housing portions 314 and 316 of the accumulator 310 may be joined in a threaded arrangement and include a plurality of o-rings for fluid sealing.

There is shown in FIG. 14 a piston assembly 410 according to a twelfth embodiment. The assembly 410 includes a rod 412 and a piston 414. The piston 414 includes a plurality of slots or apertures 416 that allow for fluid to flow into and out of an interior chamber of the piston 414. In the illustrated embodiment, the apertures 416 are generally tapered or diamond-shaped apertures though the apertures may have other desired shapes. The apertures 416 are formed such that at the end travel of the piston rod 412 there is a portion or volume of fluid between a head (not shown) of the piston rod 412 and a respective end of the interior chamber of the piston 414 that is not in communication with the apertures 416. In operation, the tapered geometry of the diamond shaped apertures 416 provides increased resistance to fluid flow around the head of the rod 412 at the end travel and thus dampens the travel of the rod 412.

There is shown in FIGS. 15 and 16 a piston assembly 510 according to a thirteenth embodiment. In this embodiment, the assembly 510 includes a rod 512, a piston 514, and a high-pressure seal and cushion 516. The cushion 516 is mounted on one end 520 of the piston 514. The cushion 516 includes a plurality, six shown, of protrusions 518 extending away from the end 520 of the piston 514 opposite the piston rod 512. In operation, the cushion 516 dampens the travel of the piston 514 as the end 520 of the piston 514 approaches a piston housing (not shown). In operation, the protrusions 518 act as contact buffers between the piston 514 and the piston housing. Preferably, the protrusions 518 are made of a resilient elastomer or plastic, although such is not required.

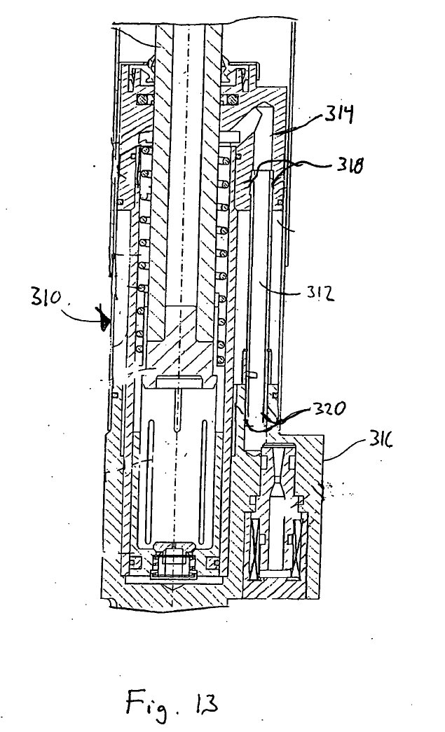

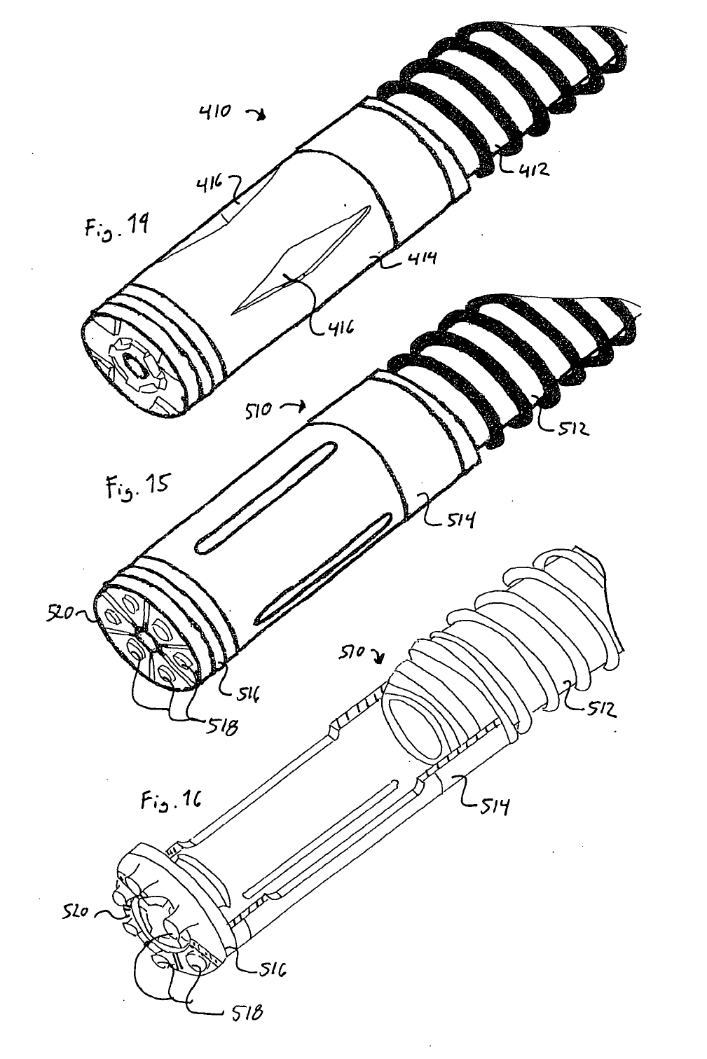

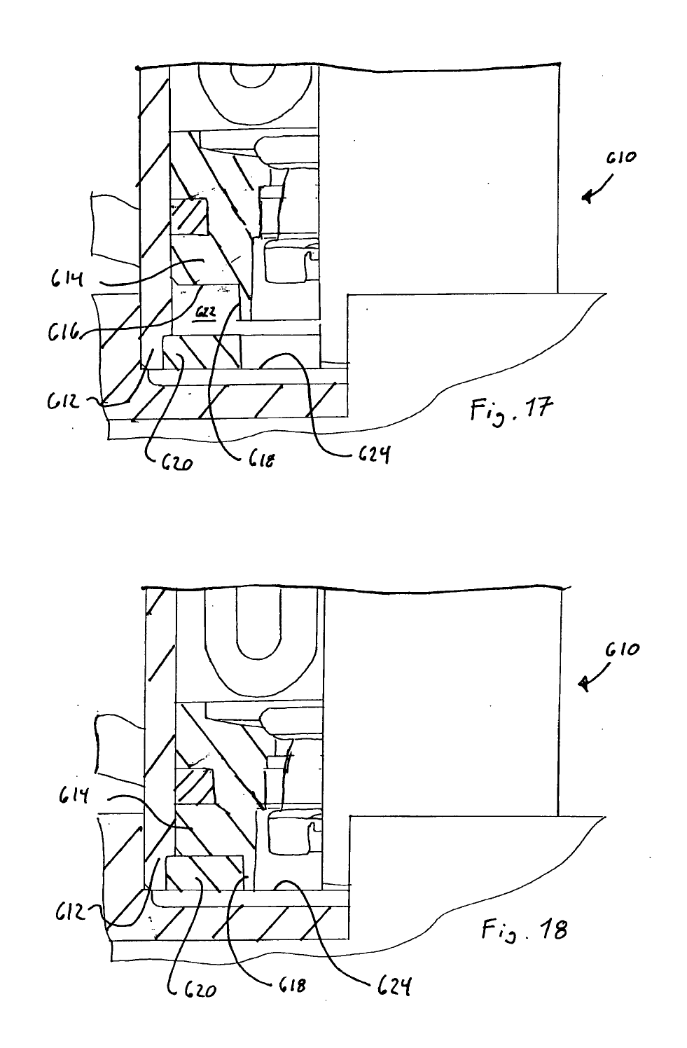

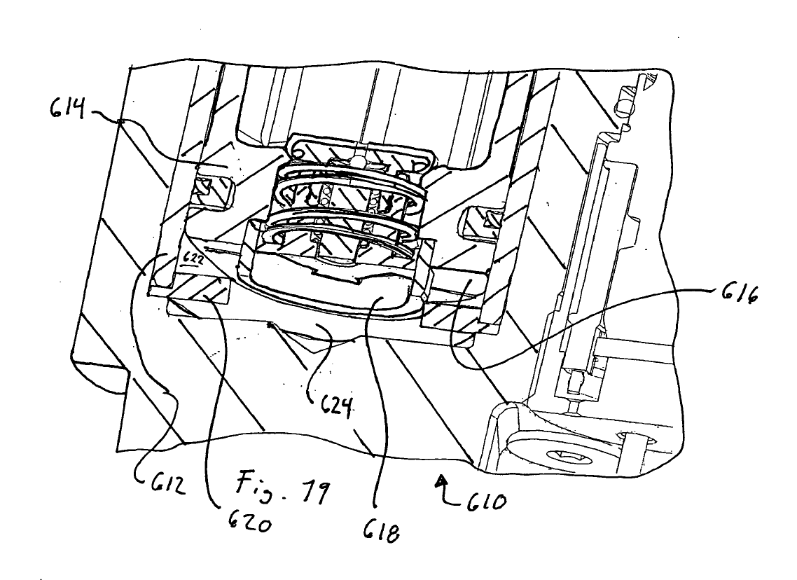

There is shown in FIGS. 17-19 an actuator 610 according to a fourteenth embodiment. In this embodiment, the actuator 610 includes a piston housing 612 and a piston 614. An end face 616 of the piston 614 is formed with a protruding neck 618. A collar 620, in the form of an annular washer shaped metal plate, is disposed in an end 624 of the housing 612 facing the end face 616. The collar 620 and the end face 616 cooperate to create a pocket of dampening hydraulic fluid 622 with in the housing 612. In operation, hydraulic fluid is captured between the end face 616 of the piston 614 and the collar 620 to dampen the travel of the piston 614 as the piston 614 moves toward the end 624 of the housing 612, the end of the piston travel being shown in FIGS. 18 and 19.

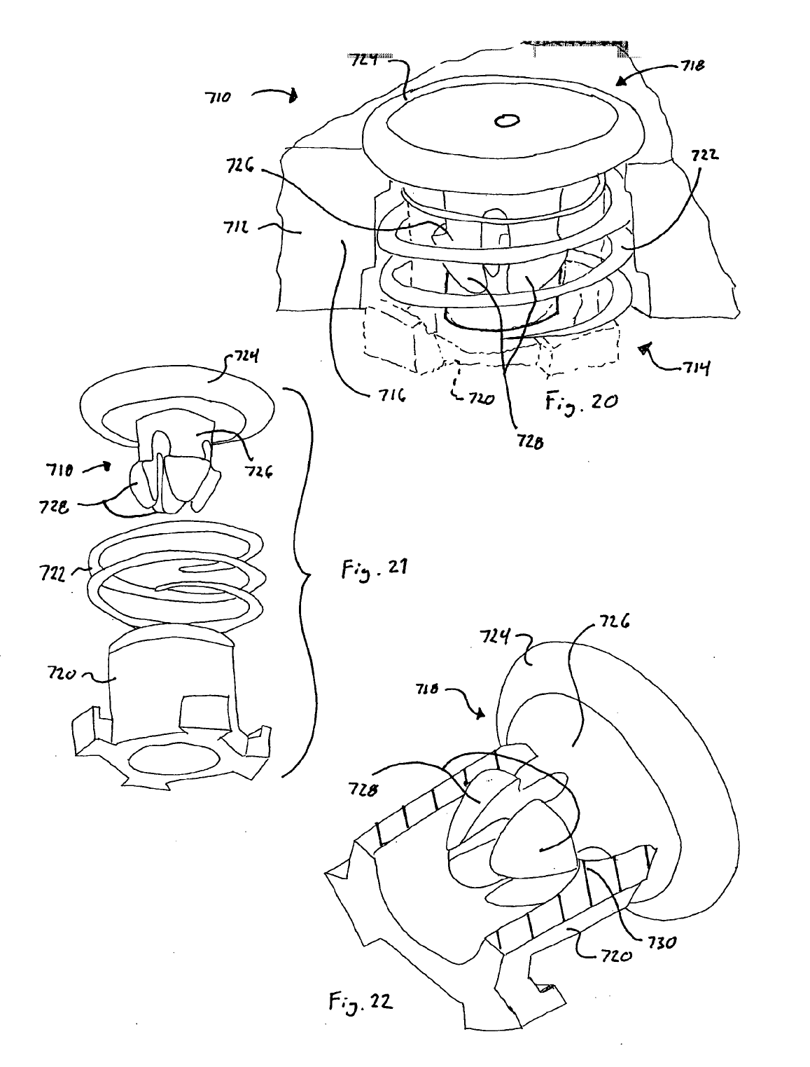

There is shown in FIGS. 20-22 a portion of an actuator 710 according to a fifteenth embodiment. As shown in this embodiment, the actuator 710 includes a piston 712 having a check valve assembly 714. In this embodiment, the check valve assembly 714 is disposed or secured in an end 716 of the piston 712 by a snap fit arrangement. The check valve assembly includes a cap 718, a valve housing 720 and a spring 722 disposed therebetween. Preferably, the cap 718 and the valve housing are made from plastic. Most preferably, the cap 718 includes an over molded section 724 that acts as a seal between a main body 726 of the cap 718 and the end 716 of the piston 712. As best shown in FIG. 22, in this embodiment the main body 726 of the cap 718 includes a plurality of fingers or tangs 728. When the check valve assembly 714 is assembled the tangs 728 operatively engage a flange 730 within the housing 720 to secure the cap 718 and the housing 720 together. In an alternative embodiment, the check valve assembly 714 may be made from steel and press fit or otherwise secured to the end 716 of the piston 712 (not shown). In such an arrangement, the check valve assembly may also include a separate sealing member, such as o-ring.

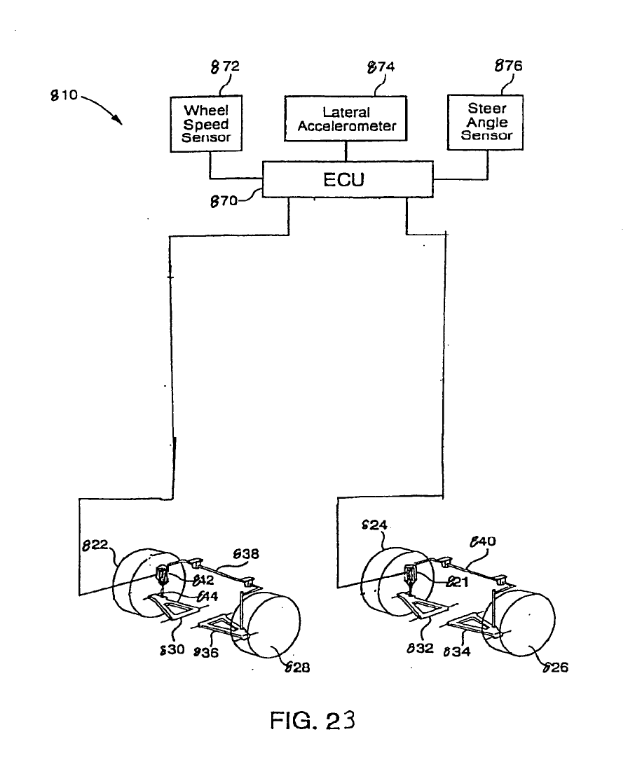

FIG. 23 is a schematic view of a vehicle system utilizing an actuator for a roll control system according to a sixteenth preferred embodiment of the present invention.

FIG. 23 show a system 810 for controlling the roll of a motor vehicle. The system 810 comprises an anti-roll lock mechanism 812. In the embodiment shown in FIG. 23, a second, rear anti-roll lock mechanism 821 is also provided.

Each of wheels 822, 824, 826 and 828 of the vehicle is rotationally mounted about a substantially horizontal axis to a member such as suspension arms 830, 832, 834 and 836, respectively, which form part of an unsprung portion of the vehicle. The unsprung portion of the vehicle is in turn connected to a sprung portion of the vehicle through the anti-roll lock mechanisms 812 and 821 and anti-roll or anti-sway bars 838 and 840. Each of the anti-roll lock mechanisms 812 and 821 includes a casing 842 and an input rod 844 reciprocally disposed in the casing.

The following description will describe the structure and operation of the lock mechanism 812 the associated roll bar 838 and the associated suspension arms 830 and 36. Unless specifically stated otherwise the structure and operation of the lock mechanism 821, the associated roll bar 840 and the associated suspension arms 832 and 834 will be similar.

One of the casing 842 and the input rod 844 of the anti-roll lock mechanism 812 is drivingly connected to the associated anti-roll bar 838. The other of the casing 842 and the input rod 844 is drivingly connected to the suspension arm 830. In the embodiment shown in FIG. 23, for example, the casing 842 of the front anti-roll lock mechanism 812 is connected to one free end of the front anti-roll bar 838, while the portion of the input rod 844 extending generally downwardly from the casing 842 is connected to the front right suspension arm 830. Similarly, the rear anti-roll bar 840 is coupled to the casing 842 of the right rear anti-roll lock mechanism 821 while the input rod 844 of the anti-roll lock mechanism 821 is connected to the suspension arm 832.

An electronic control unit (ECU) 870 is provided to process inputs from one or more wheel speed sensors 872, a lateral accelerometer sensor (accelerometer) 874, and a steering angle sensor 876.

In operation, the ECU 870 receives signals from the one or more wheel speed sensors 872, the lateral accelerometer sensor (accelerometer) 874, and the steering angle sensor 876 and controls each of the anti-roll lock mechanisms 812 and 821 as is described below. When the vehicle is traveling straight with little roll being introduced into the vehicle, the ECU 870 can unlock the anti-roll lock mechanism 812. When the anti-roll lock mechanism 812 is unlocked, the input rod 844 can move relative to the casing 842, thus permitting the associated free end of the anti-roll bar 838 to move freely relative to the suspension arm 830. This gives the vehicle a more comfortable ride when traveling relatively straight, similar to a vehicle without any anti-roll bar.

However, as discussed above, when the vehicle is not traveling straight it is generally desirable to counter the roll of the vehicle for improved comfort and performance. The motor vehicle may begin a relatively high speed left hand turn, for example, which in absence of compensation by the system 810 would cause the unsprung portion of the vehicle to tend to roll generally clockwise about the longitudinal axis of the vehicle, helping urge the occupants of the vehicle to the outside of the turn (sliding downhill).

At the beginning of such a maneuver, the sensors 872, 874 and 876 of the present invention signal the instantaneous conditions to the ECU 870. The ECU 870 in turn locks each of the anti-roll lock mechanisms 812 and 821. This permits the anti-roll bars 838 and 840 to act to counteract the roll of the vehicle in a manner similar to conventional anti-roll bars.

To counteract anticipated vehicle roll in the opposite direction, for example as might be experienced during a right hand turn, the ECU 870 repeats this procedure and locks each of the anti-roll lock mechanisms 812 and 821. In either case, as the sensors 872, 874 and 876 indicate an instantaneous or anticipated reduction or increase in the need for stability to deter vehicle roll, the ECU locks, unlock or maintains the state of each of the anti-roll lock mechanisms 812 and 821 as appropriate.

The principle and mode of operation of this invention have been explained and illustrated with regards to particular embodiments. However, it must be understood that this invention may be practiced otherwise than as specifically explained and illustrated without departing from its spirit or scope.

What is claimed is:

1. A hydraulically operated actuator for controlling a roll of a vehicle, said actuator being connected between a first mass of said vehicle and a second mass of said vehicle, said actuator comprising:
an upper mount assembly coupled to said first mass of said vehicle;
a lower mount assembly coupled to said second mass of said vehicle;
a high pressure chamber disposed between said lower mount assembly and said upper mount assembly, said high pressure chamber having a variable volume of hydraulic fluid disposed therein for selectively dampening said movement between said upper mount assembly and said lower mount assembly;
a low pressure accumulator including a first portal for selectively receiving hydraulic fluid from said high pressure chamber; and
an anti-aeration assembly for minimizing gas bubbles from transitioning between said high-pressure chamber and said accumulator, said anti-aeration assembly being disposed within said accumulator.

2. The actuator of claim 1 wherein said anti-aeration assembly includes a flow diverter for redirecting fluid flow within said accumulator for minimizing the formation of gas bubbles in the hydraulic fluid within said accumulator.

3. The actuator of claim 2 wherein said flow diverter includes a deflector for redirecting fluid flow within said accumulator.

4. The actuator of claim 3 wherein said deflector includes an angled surface area that redirects said hydraulic fluid flow entering said accumulator in a substantially horizontal direction.

5. The actuator of claim 3 wherein said deflector includes a non-linear surface that redirects said hydraulic fluid flow entering said accumulator in a substantially horizontal direction.

6. The actuator of claim 3 wherein at least a portion of said deflector is positioned over said first portal for preventing fluid flow from breaking a surface of said hydraulic fluid stored in said accumulator.

7. The actuator of claim 2 wherein said flow diverter includes a shaped conduit fluidically coupled to said first portal for redirecting said fluid flow from an upward direction to a substantially horizontal direction in said accumulator.

8. The actuator of claim 7 wherein said shaped conduit includes a curved portion for redirecting said hydraulic fluid flow entering said accumulator in a substantially horizontal direction.

9. The actuator of claim 7 wherein said shaped conduit includes a right angle bend for redirecting said hydraulic fluid flow entering said accumulator in a substantially horizontal direction.

10. The actuator of claim 7 wherein said shaped conduit flattens at an open end into said accumulator.

11. The actuator of claim 10 wherein said shaped conduit diverges at an open end into said accumulator.

12. The actuator of claim 11 wherein said flow diverter functions as a venturi for slowing said hydraulic fluid flow entering said accumulator.

13. The actuator of claim 10 wherein said shaped conduit is made of an elastomeric material.

14. The actuator of claim 7 wherein said shaped conduit is integrally formed as a part of said first portal, said shaped conduit extending in a substantially horizontal direction.

15. The actuator of claim 1 further comprising a second portal disposed on a bottom surface of said accumulator for allowing hydraulic fluid to exit said accumulator to said high-pressure chamber.

16. The actuator of claim 15 wherein said second portal is centrally formed on said bottom surface of said accumulator juxtaposed to said high-pressure accumulator.

17. The actuator of claim 15 wherein said anti-aeration assembly includes a fence portion disposed around said second portal for minimizing gas bubbles suspended in said hydraulic fluid of said accumulator from entering said second portal.

18. The actuator of claim 17 wherein said fence portion functions as a weir during cold temperature operations.

19. The actuator of claim 1 further comprising a transfer tube with a check valve fluidically coupled between said high-pressure chamber and said accumulator, said check valve preventing a return of said hydraulic fluid from said accumulator to said high-pressure chamber via said transfer tube.

20. An actuator assembly for controlling vehicle suspension rigidity, said actuator including an upper mount assembly coupled to a suspension member and a lower mount assembly coupled to a vehicle frame, a piston assembly including a piston rod and a piston, said piston rod being coupled to said upper mount assembly for maintaining a variably spaced relationship between said upper mount assembly and said lower mount assembly, said actuator assembly comprising:
an accumulator disposed between said upper mount assembly and said lower mount assembly for storing a variable amount of hydraulic fluid, said accumulator including a first portal for receiving hydraulic fluid flow into said accumulator;
a high-pressure chamber containing hydraulic fluid, said high-pressure chamber being selectively compressible;
a solenoid valve interposed between said high pressure chamber and said accumulator for selectively controlling pressure within said high pressure chamber by controlling said fluid flow from said high pressure chamber to said accumulator, and said solenoid valve when in an open position allows fluid flow from said high pressure chamber to said accumulator as said high pressure chamber is compressed; and
a flow diverter for directing a flow of hydraulic fluid flow, from said high-pressure chamber to said accumulator, within said accumulator, said flow diverter minimizing said hydraulic fluid flow into said accumulator from forming gas bubbles in said hydraulic fluid.

21. The actuator assembly of claim 20 wherein said flow diverter includes a deflector for redirecting fluid flow within said accumulator.

22. The actuator assembly of claim 21 wherein said deflector includes an angled surface area that redirects said hydraulic fluid flow entering said accumulator in a substantially horizontal direction.

23. The actuator assembly of claim 21 wherein said deflector includes a non-linear surface that redirects hydraulic fluid flow from an upward direction to a substantially horizontal direction.

24. The actuator assembly of claim 21 wherein at least a portion of said deflector is positioned over said first portal for preventing fluid flow from breaking a surface of said hydraulic fluid stored in said accumulator.

25. The actuator assembly of claim 21 further comprising a transfer tube passing through said accumulator for providing a fluid passageway between said high pressure chamber and said solenoid valve, wherein said deflector is coupled to an exterior of said transfer tube within said accumulator.

26. The actuator assembly of claim 25 further comprising a fluid conduit coupled between said high-pressure accumulator and said transfer tube for providing pressurized hydraulic fluid from said high-pressure chamber to said transfer tube, said fluid conduit coupled to a top of said high-pressure chamber.

27. The actuator assembly of claim 25 wherein said deflector functions as a spacer for positioning said transfer tube within said accumulator when being assembled between said high-pressure chamber and said solenoid valve.

28. The actuator assembly of claim 20 wherein said flow diverter includes a shaped conduit fluidically coupled to said first portal for redirecting said fluid flow from an upward direction to a substantially horizontal direction in said accumulator.

29. The actuator assembly of claim 28 wherein said shaped conduit includes a curved portion for redirecting said fluid flow from said upward direction to said substantially horizontal direction.

30. The actuator assembly of claim 28 wherein said shaped conduit includes a right angle bend for redirecting said fluid flow from said upward direction to said substantially horizontal direction.

31. The actuator assembly of claim 30 wherein said shaped conduit diverges at an open end into said accumulator.

32. The actuator assembly of claim 31 wherein said shaped conduit is made of an elastomeric material.

33. The actuator assembly of claim 31 wherein said flow diverter functions as a venturi for slowing said fluid flow entering said accumulator.

34. The actuator assembly of claim 30 wherein said shaped conduit is integrally formed to said first portal, said shaped conduit extending in a substantially horizontal direction.

35. The actuator assembly of claim 20 wherein said flow diverter decelerates said hydraulic fluid when entering said accumulator to inhibit a high-pressure hydraulic fluid flow from breaking a surface of hydraulic fluid stored in said accumulator.

36. The actuator of claim 35 further comprising a second portal disposed on a bottom surface of said accumulator for allowing hydraulic fluid to exit said accumulator to said high-pressure chamber.

37. The actuator of claim 36 wherein said second portal is centrally formed on said bottom surface of said accumulator juxtaposed to said high-pressure accumulator.

38. The actuator of claim 37 further comprising a fence portion disposed around said second portal for minimizing gas bubbles suspended in said hydraulic fluid of said accumulator from entering said second portal.

39. An anti-aeration system for a gas and fluid filled reservoir in a hydraulic suspension actuator, said actuator is hydraulically operated for controlling a roll of a vehicle, said actuator being connected between a first mass of said vehicle and a second mass of said vehicle, said actuator including an upper mount assembly coupled to said first mass of said vehicle, a lower mount assembly coupled to said second mass of said vehicle, a high pressure chamber disposed between said lower mount assembly and said upper mount assembly, said high pressure chamber having a variable volume of hydraulic fluid disposed therein for selectively dampening said movement between said upper mount assembly and said lower mount assembly, a low pressure accumulator including a first portal for selectively receiving hydraulic fluid from said high pressure chamber and a second portal disposed on a bottom surface of said accumulator for allowing hydraulic fluid to exit from said accumulator to said high pressure chamber, said anti-aeration system comprising:
a flow diverter for redirecting a flow of hydraulic fluid within said accumulator wherein said flow diverter minimizes the formation gas bubbles in said hydraulic fluid within said accumulator;
a fence portion disposed around said second portal for minimizing gas bubbles suspended in said hydraulic fluid of said accumulator from entering said second portal.

40. A hydraulic actuator for controlling a roll of a vehicle, the actuator being connected between a first mass of the vehicle and a second mass of the vehicle, the actuator comprising:
an upper mount assembly coupled to the first mass of the vehicle;
a lower mount assembly coupled to the second mass of the vehicle;
a chamber disposed between the upper mount assembly and the lower mount assembly, the chamber having a variable volume of hydraulic fluid disposed therein for selectively controlling the movement between the upper mount assembly and the lower mount assembly; and
an accumulator for receiving hydraulic fluid from the chamber;
wherein the actuator further comprises an anti-aeration assembly disposed within the accumulator for minimizing aeration of hydraulic fluid transitioning between the chamber and the accumulator.

41. The actuator of claim 40 wherein the anti-aeration assembly includes an investment casting with an integral flow deflector.

42. The actuator of claim 41 wherein the casting and the deflector are formed form plastic.

43. A hydraulic actuator for controlling a roll of a vehicle, the actuator being connected between a first mass of the vehicle and a second mass of the vehicle, the actuator comprising:
an upper mount assembly coupled to the first mass of the vehicle; and
a lower mount assembly coupled to the second mass of the vehicle;
wherein the upper and lower mount assemblies are joined by a metal fused component.

44. The actuator of claim 43 wherein the metal fused component is a high-pressure return tube.

45. The actuator of claim 43 wherein the metal fused component is oven brazed in a neutral atmosphere furnace.

46. A hydraulic actuator for controlling a roll of a vehicle, the actuator being connected between a first mass of the vehicle and a second mass of the vehicle, the actuator comprising:
an upper mount assembly coupled to the first mass of the vehicle;
a lower mount assembly coupled to the second mass of the vehicle; and
a piston assembly including a rod and a piston controlling the movement between the upper mount assembly and the lower mount assembly;
wherein at least one end of travel of the rod is dampened by a portion of hydraulic fluid.

47. The actuator of claim 46 wherein the portion of hydraulic fluid is between a head of the rod and an end of a chamber formed in the piston.

48. The actuator of claim 46 wherein the piston includes a plurality of apertures for fluid to flow into and out of a piston chamber formed therein and wherein the apertures provide increased resistance to fluid flow around a head of the rod at the end of travel.

49. The actuator of claim 48 wherein the apertures are tapered toward ends of the piston.

50. The actuator of claim 48 wherein the apertures are diamond shaped slots.

51. A hydraulic actuator for controlling a roll of a vehicle, the actuator being connected between a first mass of the vehicle and a second mass of the vehicle, the actuator comprising:
an upper mount assembly coupled to the first mass of the vehicle;
a lower mount assembly coupled to the second mass of the vehicle; and
a piston assembly including a rod and a piston controlling the movement between the upper mount assembly and the lower mount assembly;
wherein the piston assembly includes a cushion that dampens travel of the piston as the piston moves toward an end of a piston housing.

52. The actuator of claim 51 wherein the cushion is mounted on an end of the piston facing the end of the piston housing.

53. The actuator of claim 51 wherein the cushion includes a plurality of protrusions.

54. The actuator of claim 53 where the protrusions are equally spaced about the cushion.

55. The actuator of claim 53 wherein the protrusions extend away from an end of the piston opposite the rod.

56. A hydraulic actuator for controlling a roll of a vehicle, the actuator being connected between a first mass of the vehicle and a second mass of the vehicle, the actuator comprising:
an upper mount assembly coupled to the first mass of the vehicle;
a lower mount assembly coupled to the second mass of the vehicle; and
a piston assembly including a rod and a piston controlling the movement between the upper mount assembly and the lower mount assembly, the piston assembly disposed in a piston housing;
wherein a collar disposed in the piston housing cooperates with the piston to create a pocket of dampening hydraulic fluid within the housing to dampen the travel of the piston as the piston moves toward an end of the housing.

57. The actuator of claim 56 wherein an end face of the piston is formed with a protruding neck.

58. The actuator of claim 56 wherein the collar is an annular washer shaped plate.

59. A hydraulic actuator for controlling a roll of a vehicle, the actuator being connected between a first mass of the vehicle and a second mass of the vehicle, the actuator comprising:
an upper mount assembly coupled to the first mass of the vehicle;
a lower mount assembly coupled to the second mass of the vehicle; and
a piston assembly including a rod and a piston controlling the movement between the upper mount assembly and the lower mount assembly;
wherein the piston assembly includes a check valve assembly in an end of the piston for controlling fluid flow into and out of an end of the piston

60. The actuator of claim 59 wherein the check valve assembly is snap fit in the end of the piston.

61. The actuator of claim 60 wherein the check valve assembly includes a cap and a valve housing wherein one of the cap and the housing includes a flange and the other one of the cap and the housing includes a plurality of tangs engaging the flange to secure the cap and the housing together.

62. The actuator of claim 59 wherein the check valve assembly includes a cap having an main body and an over-molded section.

63. The actuator of claim 59 wherein the check valve assembly includes a cap and a valve housing, the cap and the housing being made of plastic.
